(19) United States
(12) Patent Application Publication
(10) Pub. No.: US 2025/0217987 A1
(43) Pub. Date: Jul. 3, 2025

(54) METHOD AND APPARATUS FOR MULTI-TASK LEARNING

(71) Applicants: HYUNDAI MOTOR COMPANY, Seoul (KR); Kia Corporation, Seoul (KR)

(72) Inventors: Jung Gee KIM, Seoul (KR); Yu Jin YUN, Seoul (KR); Geon KANG, Pyeongtaek-si (KR)

(73) Assignees: HYUNDAI MOTOR COMPANY, Seoul (KR); Kia Corporation, Seoul (KR)

(21) Appl. No.: 18/677,162

(22) Filed: May 29, 2024

(30) Foreign Application Priority Data
Dec. 27, 2023 (KR) 10-2023-0193511

(51) Int. Cl. G06T 7/10; G06T 3/4046; G06T 7/50; G06T 7/80

(52) U.S. Cl. CPC G06T 7/10; G06T 3/4046; G06T 7/50; G06T 7/80; G06T 2207/20081; G06T 2207/20084

(57) ABSTRACT

A multi-task learning method according to an embodiment of the present disclosure may include generating, by a generation device, a first feature based on a first input image through a multi-task encoder, generating, by the generation device, a first output image based on the first feature through a first decoder for a first task, generating, by the generation device, a first loss based on the first output image and a first ground truth (GT) for the first task, generating, by the generation device, a second feature based on the first input image through a pretrained first encoder for a second task, generating, by the generation device, a second loss based on the first feature and the second feature, and learning, by a learning device, the multi-task encoder and the first decoder based on the first loss and the second loss.

### CROSS-REFERENCE TO RELATED APPLICATION

This application claims the benefit of priority to Korean Application No. 10-2023-0193511, filed in the Korean Patent Intellectual Property Office on Dec. 27, 2023, the entire contents of which are incorporated herein by reference.

### TECHNICAL FIELD

The present disclosure relates to an apparatus for learning an artificial intelligence model, and a method thereof, and more specifically, relates to an apparatus for multi-task learning and a method thereof.

### BACKGROUND

Various methods are being researched to improve the performance of neural networks. The multi-task learning method may be a method of learning two or more tasks through one network and may be a method for improving neural network performance. The performance of the multi-task learning may be higher than the performance of single-task learning if the number of tasks is great and the number of data samples belonging to each task is small. Moreover, two or more tasks may be learned through a single network, and thus the multi-task learning may be used efficiently even in situations where only limited computing resources are present, such as autonomous driving situations.

Furthermore, a semi-supervised learning method may be used as a method for improving the performance of neural networks.

The semi-supervised learning is a learning method for improving learning performance by using labeled data and unlabeled data together for learning.

To improve the performance of a neural network, there may be a need for a method of using both a semi-supervised learning method and a multi-task learning method.

### SUMMARY

The present disclosure was made to solve the above-mentioned problems occurring in the prior art while advantages achieved by the prior art are maintained intact.

An aspect of the present disclosure provides a multi-task learning method and an apparatus thereof.

An aspect of the present disclosure provides a method of performing semi-supervised learning on a multi-task model, and an apparatus thereof.

An aspect of the present disclosure provides a method of performing multi-task learning on a depth image by using camera calibration information, and an apparatus thereof.

An aspect of the present disclosure provides a method of performing semi-supervised learning on a multi-task model without an additional module, and an apparatus thereof.

An aspect of the present disclosure provides a method of performing learning such that a distance between an output feature of a single model encoder of a task without a ground truth (GT) and an output feature of a multi-task encoder is closer, and an apparatus thereof.

An aspect of the present disclosure provides a method of preventing learning from being biased towards a task with GT even though a multi-task learning model is learned based on partially annotated data, and an apparatus thereof.

An aspect of the present disclosure provides a method of performing multi-task learning even though the types of inputs are different from each other, and an apparatus thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a multi-task learning method may include generating, by a generation device, a first feature based on a first input image through a multi-task encoder, generating, by the generation device, a first output image based on the first feature through a first decoder for a first task, generating, by the generation device, a first loss based on the first output image and a first ground truth (GT) for the first task, generating, by the generation device, a second feature based on the first input image through a pretrained first encoder for a second task, generating, by the generation device, a second loss based on the first feature and the second feature, and learning, by a learning device, the multi-task encoder and the first decoder based on the first loss and the second loss.

According to an embodiment, the multi-task learning method may further include generating, by the generation device, a third feature based on a second input image through the multi-task encoder, generating, by the generation device, a second output image based on the third feature through a second decoder for the second task, generating, by the generation device, a third loss based on the second output image and a second GT for the second task, generating, by the generation device, a fourth feature based on the second input image through a pretrained second encoder for the first task, generating, by the generation device, a fourth loss based on the third feature and the fourth feature, and learning, by the learning device, the multi-task encoder and the second decoder based on the third loss and the fourth loss.

According to an embodiment, the generating of the second loss may include scaling, by a scaling device, the first feature to correspond to the second feature, and generating, by the generation device, the second loss based on the scaled first feature and the second feature.

According to an embodiment, the scaling of the first feature may include scaling, by the scaling device, the first feature by inputting the first feature into a convolution layer.

According to an embodiment, the generating of the second loss may include generating, by the generation device, the second loss by calculating a distance between the scaled first feature and the second feature.

According to an embodiment, the pretrained first encoder for the second task may be an encoder with a structure that is the same as a structure of the multi-task encoder.

According to an embodiment, the first task may be an image segmentation task, and the second task may be a depth estimation task.

According to an embodiment, the generating of the first output image may include generating, by the generation device, the first output image based on the first feature and camera calibration information.

According to an embodiment, the learning of the multi-task encoder and the first decoder may include learning, by the learning device, the multi-task encoder and the first decoder while fixing a parameter of the pretrained first encoder.

According to an aspect of the present disclosure, a multi-task learning apparatus may include a memory that stores computer-executable instructions, a generation device including a first processor configured to access the memory and to execute the computer-executable instructions, wherein the generation device is configured to generate a first feature based on a first input image by using a multi-task encoder, generate a first output image based on the first feature by using a first decoder for a first task, generate a first loss based on the first output image and a GT for the first task, generate a second feature based on the first input image by using a pretrained first encoder for a second task, and generate a second loss based on the first feature and the second feature; and a learning device including a second processor configured to access the memory and to execute the computer-executable instructions, wherein the learning device is configured to learn the multi-task encoder and the first decoder based on the first loss and the second loss.

According to an embodiment, the generation device may be configured to generate a third feature based on a second input image by using the multi-task encoder, generate a second output image based on the third feature by using a second decoder for the second task, generate a third loss based on the second output image and a second GT for the second task, generate a fourth feature based on the second input image by using a pretrained second encoder for the first task, and generate a fourth loss based on the third feature and the fourth feature. The learning device may be configured to learn the multi-task encoder and the second decoder based on the third loss and the fourth loss.

According to an embodiment, the multi-task learning apparatus may further include a scaling device including a third processor configured to access the memory and to execute the computer-executable instructions. The scaling device may be configured to scale the first feature to correspond to the second feature. The generation device may be configured to generate the second loss based on the scaled first feature and the second feature.

According to an embodiment, the scaling device may be configured to scale the first feature by inputting the first feature into a convolution layer.

According to an embodiment, the generation device may be configured to generate the second loss by calculating a distance between the scaled first feature and the second feature.

According to an embodiment, the pretrained first encoder for the second task may be an encoder with a structure that is the same as a structure of the multi-task encoder.

According to an embodiment, the first task may be an image segmentation task, and the second task may be a depth estimation task.

According to an embodiment, the generation device may be configured to generate the first output image based on the first feature and camera calibration information.

According to an embodiment, the learning device may be configured to learn the multi-task encoder and the first decoder while fixing a parameter of the pretrained first encoder.

The features briefly summarized above with respect to the present disclosure are merely aspects of the detailed description of the present disclosure described below, and do not limit the scope of the present disclosure.

### BRIEF DESCRIPTION OF THE DRAWINGS

The above and other objects, features and advantages of the present disclosure will be more apparent from the following detailed description taken in conjunction with the accompanying drawings:

FIG. 1 is a flowchart for describing a multi-task learning method, according to an embodiment of the present disclosure;

FIG. 2 is a diagram for describing a multi-task learning method, according to an embodiment of the present disclosure;

FIG. 3 is a diagram for describing a multi-task learning method, according to an embodiment of the present disclosure;

FIG. 4 is a diagram for describing a multi-task learning method, according to an embodiment of the present disclosure;

FIG. 5A is a diagram for describing a multi-task learning method, according to a comparative example;

FIG. 5B is a diagram for describing a multi-task learning method, according to a comparative example;

FIG. 6 is a diagram for describing a multi-task learning method, according to a comparative example;

FIG. 7 is a diagram for describing a multi-task learning method, according to an embodiment of the present disclosure;

FIG. 8 is a block diagram of a multi-task learning apparatus, according to an embodiment of the present disclosure; and

FIG. 9 is a block diagram of a computing system for executing a multi-task learning method, according to an embodiment of the present disclosure.

### DETAILED DESCRIPTION

Hereinafter, various embodiments of the present disclosure will be described in detail with reference to the accompanying drawings, so that those skilled in the art may easily carry out the present disclosure. However, the disclosure may be embodied in many different forms and should not be construed as limited to the embodiments set forth herein.

In describing the embodiments of the present disclosure, if a specific description of the related art is deemed to obscure the subject matter of the embodiments of the present disclosure, the detailed description will be omitted. In addition, in the drawings, parts that are not related to the description of the present disclosure are omitted, and similar parts are given similar reference numerals.

In the present disclosure, it will be understood that if an element is referred to as being “connected” or “coupled” to another element, it may be directly connected or indirectly connected to another element. In addition, if some part ‘includes’ or “possess” some elements, unless explicitly described to the contrary, it means that other elements may be further included but not excluded.

In the present disclosure, expressions such as “first,” or “second,” and the like, may express their elements regardless of their priority or importance and may be used to distinguish one element from another element but is not limited to these components. Therefore, without departing from the scope of the present disclosure, a first component of one embodiment may be referred to as a second component of another embodiment. Similarly, a second component of one embodiment may be referred to as a first component of another embodiment.

In the present disclosure, components that are distinguished from each other are only for clearly describing characteristics, and do not mean that the components are necessarily separated. That is, a plurality of components may be integrated to form a single hardware or software unit, or a single component may be distributed to form a plurality of hardware or software units. Accordingly, such integrated or distributed embodiments are included in the scope of the present disclosure, even though not mentioned separately.

In the present disclosure, components described in various embodiments do not necessarily mean essential components, and some may be optional components. Therefore, an embodiment composed of a subset of components described in an embodiment is also included in the scope of the present disclosure. Moreover, an embodiment in which another component is additionally included in components described in the various embodiments is also included in the scope of the present disclosure.

In the present disclosure, expressions of positional relationships used herein, such as upper, lower, left, and right are described for convenience of description. If viewing the drawings shown in this specification in reverse, the positional relationship described in the specification may be interpreted in the opposite manner.

In the disclosure, the expressions “A or B”, “at least one of A or B”, “at least one of A or B”, “A, B, or C”, “at least one of A, B, or C”, and “at least one of A, B, or C” may include any and all combinations of one or more of the associated listed items.

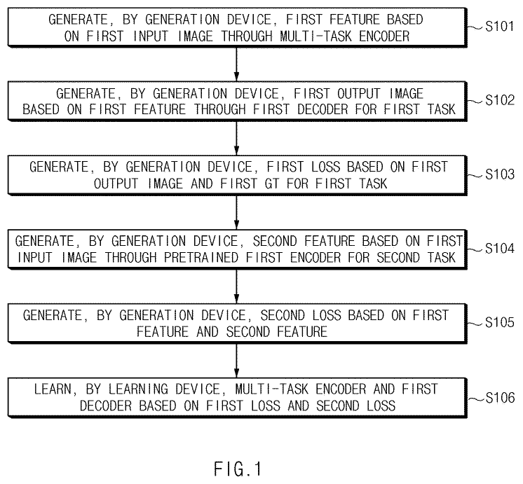

Hereinafter, various embodiments of the present disclosure will be described in detail with reference to FIGS. 1 to 9.

FIG. 1 is a flowchart for describing a multi-task learning method, according to an embodiment of the present disclosure.

Referring to FIG. 1, according to a multi-task learning method according to an embodiment of the present disclosure, in S101, a generation device may generate a first feature based on a first input image through a multi-task encoder. The multi-task encoder may also be referred to as a multi-task learning encoder. The first input image may correspond to an RGB image. The multi-task encoder may include at least one convolution layer. Moreover, the multi-task encoder may be implemented through software, but is not limited thereto. The first feature may refer to an output feature of a multi-task encoder that receives the first input image.

According to the multi-task learning method, in S102, the generation device may generate the first output image based on the first feature through a first decoder for a first task. The first task may be an image segmentation task or a depth estimation task. For example, if the first task is an image segmentation task, the first output image may be an image created by performing image segmentation on the first input image. If the first task is a depth estimation task, the first output image may be an image created by estimating the depth of the first input image.

The first decoder may be implemented through software, but is not limited thereto. The first decoder may be configured to generate the first output image by performing the first task based on the input feature. For example, if the first task is depth estimation, the first decoder may generate a depth image based on the input feature and camera calibration information. The depth image includes 3D information unlike a segmentation image, and thus the camera calibration information including 3D information may be required to create the depth image. The camera calibration information may include information about a camera external parameter or a camera internal parameter.

According to the multi-task learning method, in S103, the generation device may generate a first loss based on a first output image and a first GT for a first task.

According to the multi-task learning method, in S104, the generation device may generate a second feature based on the first input image through a first encoder pretrained for a second task. If the first task is an image segmentation task, the second task may be a depth estimation task. On the other hand, if the first task is a depth estimation task, the second task may be an image segmentation task. The second feature may be the output feature of the pretrained first encoder that receives the first input image.

The pretrained first encoder may be an encoder trained through a model for the second task by using the GT for the second task. In other words, the one corresponding to the encoder among the encoders and decoders included in the second task performance model learned using the GT for the second task may be a pretrained first encoder. Moreover, the pretrained first encoder may be an encoder with a structure the same as the multi-task encoder. For example, the pretrained first encoder and the multi-task encoder may be encoders that perform learning through the same number of parameters. The multi-task learning method may perform semi-supervised learning without an additional module by using pretrained encoders with the same structure as the multi-task encoder.

According to the multi-task learning method, in S105, the generation device may generate a second loss based on the first feature and the second feature. In detail, the multi-task learning method may generate the second loss based on the scaled first feature and second feature. The second loss may also be referred to as a “first consistency loss”. The first consistency loss may refer to a result of calculating a distance between the scaled first feature and the second feature. In detail, the first consistency loss may refer to a result of calculating a distance such as a cosine distance and a Euclidean distance between the first feature and the second feature. For example, the multi-task learning method may generate the first consistency loss by calculating a cosine distance of “{1−(cosine similarity between the scaled first feature and the second feature)}”.

The multi-task learning method may scale the first feature to correspond to the second feature. The scaling may refer to a task of matching ranges of different variable values to a specific level. The multi-task learning method may scale the first feature by inputting the first feature into a convolution layer.

According to the multi-task learning method, in S106, a learning device may learn a multi-task encoder and a first decoder based on the first loss and the second loss. For example, the multi-task learning method may learn a multi-task model such that a distance between the scaled first feature and the second feature becomes closer.

Also, the multi-task learning method may freeze the pretrained first encoder and then may learn the multi-task encoder and the first decoder. In other words, the multi-task learning method may learn the multi-task encoder and the first decoder while fixing a parameter of the pretrained first encoder. Accordingly, if multi-task learning is performed, the weight of the pretrained first encoder may not be updated.

Although not shown in FIG. 1, according to the multi-task learning method, the generation device may generate the third feature based on the second input image through the multi-task encoder. The second input image may correspond to an RGB image. The third feature may refer to an output feature of a multi-task encoder that receives the second input image.

According to the multi-task learning method, the generation device may generate the second output image based on the third feature through a second decoder for a second task. The second task may be an image segmentation task or a depth estimation task. For example, if the second task is an image segmentation task, the second output image may be an image created by performing image segmentation on the second input image. If the second task is a depth estimation task, the second output image may be an image created by estimating the depth of the second input image.

The second decoder may be implemented through software, but is not limited thereto. The second decoder may be configured to generate the second output image by performing the second task based on the input feature. For example, if the second task is a depth estimation task, the second decoder may generate a depth image based on the input feature and camera calibration information. The depth image includes 3D information unlike a segmentation image, and thus the camera calibration information including 3D information may be required to create the depth image. The camera calibration information may include information about a camera external parameter or a camera internal parameter.

According to the multi-task learning method, the generation device may generate a third loss based on a second output image and a second GT for a second task.

According to the multi-task learning method, the generation device may generate a fourth feature based on the second input image through the second encoder pretrained for the first task. If the first task is an image segmentation task, the second task may be a depth estimation task. On the other hand, if the first task is a depth estimation task, the second task may be an image segmentation task. The fourth feature may be the output feature of the pretrained second encoder that receives the second input image.

The pretrained second encoder may be an encoder trained through a model for the second task by using the GT for the first task. In other words, the one corresponding to the encoder among the encoders and decoders included in the second task performance model learned using the GT for the second task may be a pretrained second encoder. Moreover, the pretrained second encoder may be an encoder with a structure the same as the multi-task encoder. For example, the pretrained second encoder and the multi-task encoder may be encoders that perform learning through the same number of parameters. The multi-task learning method may perform semi-supervised learning without an additional module by using pretrained encoders with the same structure as the multi-task encoder.

According to the multi-task learning method, the generation device may generate a fourth loss based on the third feature and the fourth feature. In detail, the multi-task learning method may generate the fourth loss based on the scaled third feature and the fourth feature. The fourth loss may also be referred to as a second consistency loss. The second consistency loss may refer to a result of calculating a distance between the scaled third feature and the fourth feature. For example, the multi-task learning method may generate the second consistency loss by calculating a cosine distance of “{1−(cosine similarity between the scaled third feature and the fourth feature)}”.

The multi-task learning method may scale the third feature to correspond to the fourth feature. The multi-task learning method may scale the third feature by inputting the third feature into a convolution layer.

According to the multi-task learning method, a learning device may learn a multi-task encoder and a second decoder based on the third loss and the fourth loss. For example, the multi-task learning method may learn a multi-task model such that a distance between the scaled third feature and the fourth feature becomes closer.

Also, the multi-task learning method may freeze the pretrained second encoder and then may learn the multi-task encoder and the second decoder. In other words, the multi-task learning method may learn the multi-task encoder and the second decoder while fixing a parameter of the pretrained second encoder. Accordingly, if multi-task learning is performed, the weight of the pretrained second encoder may not be updated.

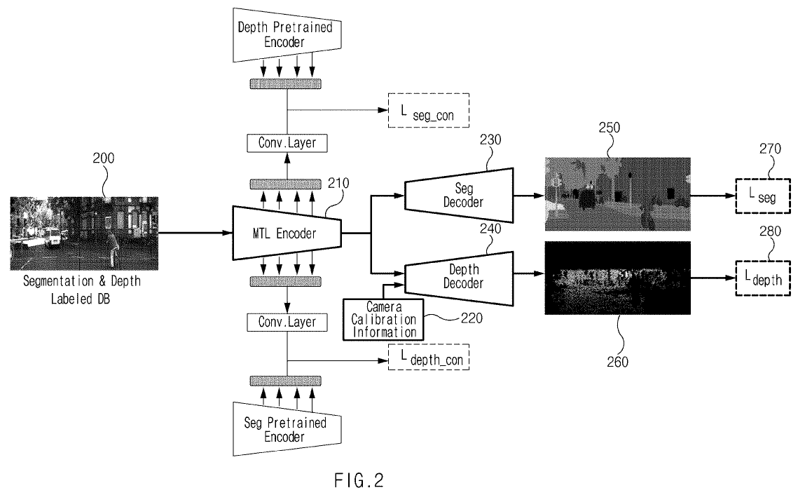

FIG. 2 is a diagram for describing a multi-task learning method, according to an embodiment of the present disclosure.

Referring to FIG. 2, a multi-task learning method according to an embodiment of the present disclosure may perform multi-task learning based on segmentation labeled data and depth labeled data 200. The segmentation labeled data and depth labeled data 200 may be at least one input image, GT for the segmentation image corresponding to the input image, and data including GT for the depth image corresponding to the input image.

The segmentation labeled data and depth labeled data 200 may be input to a multi-task encoder 210. The multi-task encoder 210 may generate an output feature based on the segmentation labeled data or depth labeled data 200.

The output feature may be input to a segmentation decoder 230 and a depth decoder 240. The segmentation decoder 230 and the depth decoder 240 may respectively correspond to a first decoder for the first task and a second decoder for the second task described in relation to FIG. 1, or may respectively correspond to the second decoder for the second task and the first decoder for the first task. The segmentation decoder 230 may generate a segmentation image 250 based on the input feature. Moreover, the depth decoder may generate a depth image 260 based on the input feature and camera calibration information 220. Because the depth image 260 includes 3D information, the depth image 260 may be generated based on the camera calibration information 220.

The multi-task learning method may generate a segmentation loss L_{seg} 270 based on the generated segmentation image 250 and a segmentation image GT. The segmentation loss 270 may correspond to the first loss or the third loss described with reference to FIG. 1.

The multi-task learning method may generate a depth loss L_{depth} 280 based on the generated depth image 260 and a depth image GT. The depth loss 280 may correspond to the third loss or the first loss described with reference to FIG. 1.

The multi-task learning method may learn the multi-task encoder 210, the segmentation decoder 230, and the depth decoder 240 based on the generated segmentation loss 270 and the generated depth loss 280. In other words, the multi-task learning method may update parameters of the multi-task encoder 210, the segmentation decoder 230, and the depth decoder 240 based on the segmentation loss 270 and the depth loss 280.

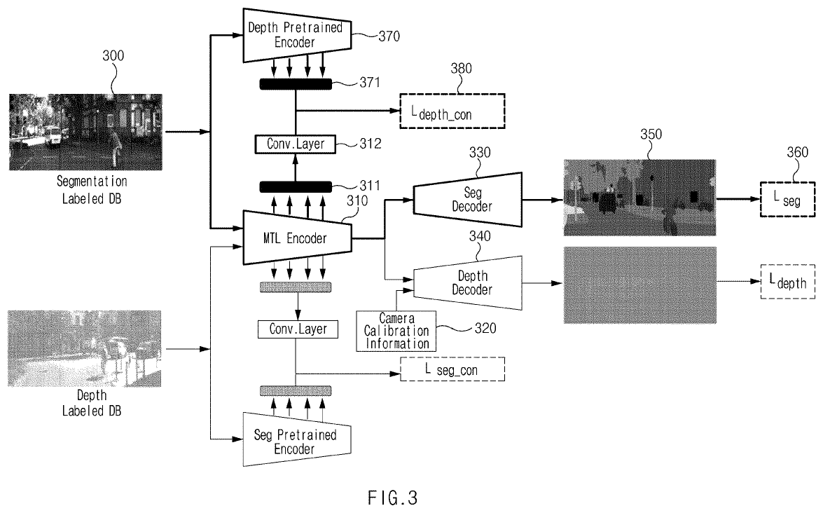

FIG. 3 is a diagram for describing a multi-task learning method, according to an embodiment of the present disclosure.

Referring to FIG. 3, a multi-task learning method according to an embodiment of the present disclosure may perform semi-supervised learning based on segmentation labeled data 300. The segmentation labeled data 300 may be data including at least one input image and GT for the segmentation image corresponding to the input image.

A multi-task encoder 310 may generate a first encoder output feature 311 based on the input image. The first encoder output feature 311 may be input to a segmentation decoder 330 to generate a segmentation image 350, and may be input to a first convolution layer 312 to generate a depth consistency loss L_{depth_con} 380.

The segmentation decoder 330 may generate the segmentation image 350 based on the first encoder output feature 311. The multi-task learning method may generate a segmentation loss L_{seg} 360 based on the segmentation image 350 and the GT for the segmentation image. Assuming that a first task is image segmentation, the segmentation loss 360 may be referred to as the “first loss”. Assuming that the first task is depth estimation, the segmentation loss 360 may also be referred to as the “third loss”.

An encoder 370 pretrained for a depth (hereinafter, referred to as a “depth pretrained encoder”) may generate a second encoder output feature 371 based on the input image. The depth pretrained encoder 370 may be an encoder with the same structure as the multi-task encoder, and may be an encoder pretrained to estimate the depth of the input image.

The first encoder output feature 311 may be scaled by being input to the first convolution layer 312. In detail, the first encoder output feature 311 may be scaled to correspond to the second encoder output feature 371 by being input to the first convolution layer 312. The multi-task learning method may generate a depth consistency loss 380 based on the scaled first encoder output feature 311 and the scaled second encoder output feature 371. Assuming that the first task is image segmentation, the depth consistency loss 380 may be referred to as the first consistency loss or the second loss. Assuming that the first task is depth estimation, the depth consistency loss 380 may also be referred to as the second consistency loss or the fourth loss. The depth consistency loss 380 may be generated by calculating a distance between the scaled first encoder output feature 311 and the scaled second encoder output feature 371.

The multi-task learning method may learn the multi-task encoder 310 and the segmentation decoder 330 based on the segmentation loss 360 and the depth consistency loss 380. In detail, the multi-task learning method may update parameters of the multi-task encoder 310 and the segmentation decoder 330 based on the segmentation loss 360 and the depth consistency loss 380. It may be seen that semi-supervised learning for multi-task is performed because learning is performed on the multi-task encoder 310 and the segmentation decoder 330 based on the segmentation labeled data 300. Moreover, because the learning is not performed on a depth decoder 340 if the learning is performed on the multi-task encoder 310 and the segmentation decoder 330, back propagation for the depth decoder 340 may not be performed. Accordingly, the learning may be performed on the multi-task encoder 310 and the segmentation decoder 330 without camera calibration information 320. Furthermore, the multi-task learning method may learn the multi-task encoder 310 and the segmentation decoder 330 after freezing the pretrained first encoder 370.

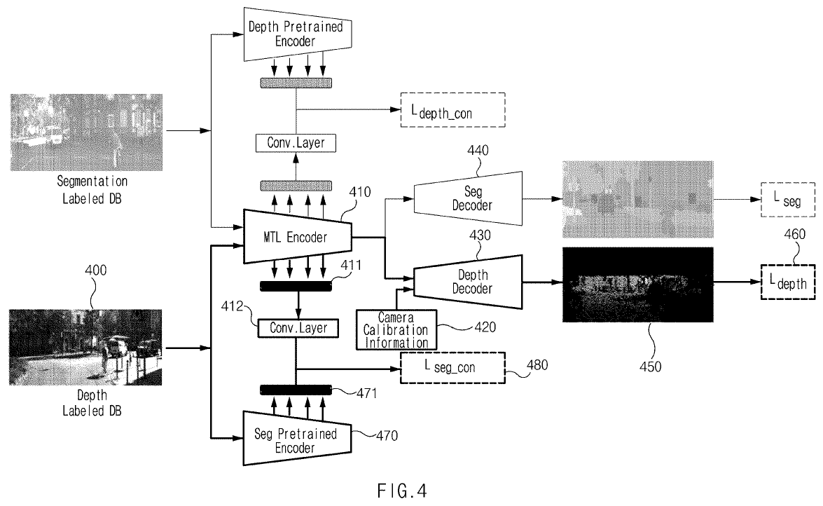

FIG. 4 is a diagram for describing a multi-task learning method, according to an embodiment of the present disclosure.

Referring to FIG. 4, a multi-task learning method according to an embodiment of the present disclosure may perform semi-supervised learning based on depth labeled data 400. The depth labeled data 400 may be data including at least one input image and GT for the depth image corresponding to the input image.

A multi-task encoder 410 may generate a third encoder output feature 411 based on the input image. The third encoder output feature 411 may be input to a depth decoder 430 to generate a depth image 450, and may be input to a second convolution layer 412 to generate a segmentation consistency loss L_{seg_con} 480.

A depth decoder 430 may generate the depth image 450 based on the third encoder output feature 411. In detail, the depth decoder 430 may generate the depth image 450 based on the third encoder output feature 411 and camera calibration information 420. The multi-task learning method may generate a depth loss L_{depth} 460 based on the depth image 450 and GT for the depth image. With regarding to FIG. 1, if the first task is image segmentation, the second task is depth estimation, and thus the depth loss 460 may correspond to the third loss. If the first task is depth estimation, the depth loss 460 may correspond to the first loss.

An encoder 470 pretrained for image segmentation (hereinafter, referred to as a “seg pretrained encoder”) may generate a fourth encoder output feature 471 based on the input image. The seg pretrained encoder 470 may be an encoder with the same structure as the multi-task encoder, and may be an encoder pretrained to perform image segmentation on the input image.

The third encoder output feature 411 may be scaled by being input to the second convolution layer 412. In particular, the third encoder output feature 411 may be scaled to correspond to the fourth encoder output feature 471 by being input to the second convolution layer 412. The multi-task learning method may generate a segmentation consistency loss 480 based on the scaled third encoder output feature 411 and the fourth encoder output feature 471. Assuming that the first task is image segmentation, the segmentation consistency loss 480 may be referred to as the second consistency loss or the fourth loss. Assuming that the first task is depth estimation, the segmentation consistency loss 480 may also be referred to as the first consistency loss or the second loss. The segmentation consistency loss 480 may be generated by calculating a distance between the scaled third encoder output feature 411 and the fourth encoder output feature 471.

The multi-task learning method may learn the multi-task encoder 410 and the depth decoder 430 based on the depth loss 460 and the segmentation consistency loss 480. In detail, the multi-task learning method may update parameters of the multi-task encoder 410 and the depth decoder 430 based on the depth loss 460 and the segmentation consistency loss 480. It may be seen that semi-supervised learning for multi-task is performed because learning is performed on the multi-task encoder 410 and the depth decoder 430 based on the depth labeled data 400. Moreover, because the learning is not performed on the segmentation decoder 440 if learning is performed on the multi-task encoder 410 and the depth decoder 430, backpropagation may not be performed on the depth decoder 430. Furthermore, the multi-task learning method may learn the multi-task encoder 410 and the depth decoder 430 after freezing the pretrained second encoder 470.

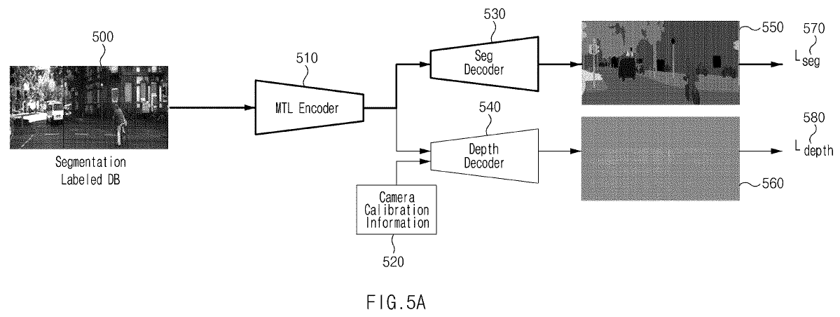

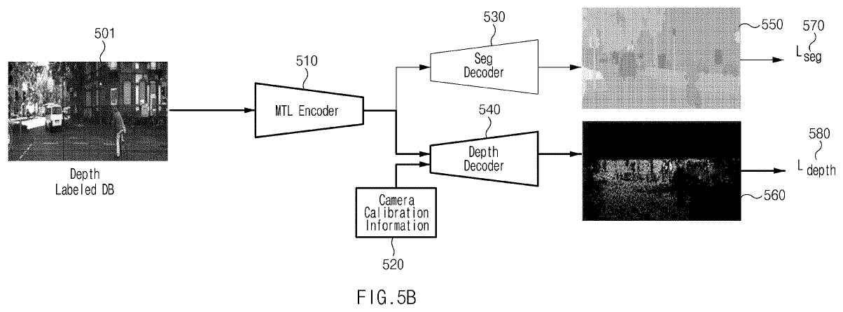

FIG. 5A is a diagram for describing a multi-task learning method, according to a comparative example. FIG. 5B is a diagram for describing a multi-task learning method, according to a comparative example.

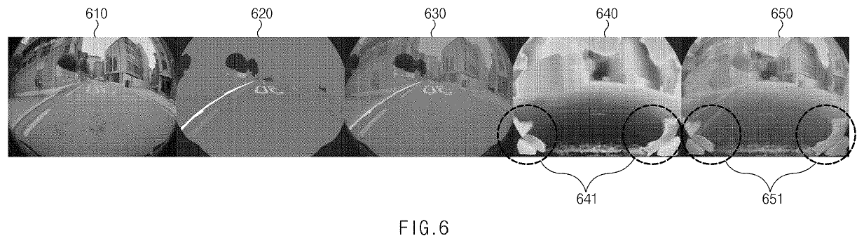

A method of performing learning based on partially annotated data without using pretrained encoders may be considered as an example of a multi-task learning method. In other words, method of performing multi-task learning without considering a consistency loss may be considered. For example, referring to FIG. 5A, a multi-task learning method according to a comparative example may perform multi-task learning based on segmentation labeled data 500. In particular, the multi-task learning method may generate a segmentation image 550 through a multi-task encoder 510 and a segmentation decoder 530, based on an input image. Moreover, the multi-task learning method may generate a segmentation loss 570 based on a segmentation image GT and a segmentation image 550. Furthermore, the multi-task learning method may perform learning on the multi-task encoder 510 and the segmentation decoder 530 based on the segmentation loss 570. In other words, unlike the multi-task learning method according to an embodiment of the present disclosure, the multi-task learning method according to a comparative example may perform multi-task learning based on only the segmentation loss 570 without a consistency loss. However, as such, if the multi-task learning is performed without a consistency loss, learning may be unstably performed on a task without GT data. An example of a result of unstably learning a task without the GT data will be described later with reference to FIG. 6.

Moreover, referring to FIG. 5B, a multi-task learning method according to a comparative example may perform multi-task learning based on depth labeled data 501. In detail, the multi-task learning method may generate a depth image 560 through the multi-task encoder 510 and the depth decoder 540 based on an input image and camera calibration information 520. Furthermore, the multi-task learning method may generate the depth loss 580 based on the depth image GT and the depth image 560. Also, the multi-task learning method may perform learning on the multi-task encoder 510 and the depth decoder 540 based on the depth loss 580. In other words, unlike the multi-task learning method according to an embodiment of the present disclosure, the multi-task learning method according to a comparative example may perform multi-task learning based on only the depth loss 580 without a consistency loss. However, as such, if the multi-task learning is performed without a consistency loss, learning may be unstably performed on a task without GT data.

FIG. 6 is a diagram for describing a multi-task learning method, according to a comparative example. Hereinafter, FIG. 6 will be described with reference to FIG. 5A.

The drawings shown in FIG. 6 are an input image 610 input to perform the method according to the comparative example of FIG. 5A described above, a segmentation image 620 created based on the input image 610, an image 630 obtained by projecting the segmentation image 620 onto the input image 610, a depth image 640 created based on the input image 610, and an image 650 obtained by projecting the depth image 640 onto the input image 610.

The multi-task learning method according to a comparative example may perform learning based on partially annotated data without using a pretrained encoder. For example, as described with reference to FIG. 5A, the multi-task learning method according to a comparative example may generate a segmentation image 550 through the multi-task encoder 510 and the segmentation decoder 530, based on an input image. Moreover, the multi-task learning method according to a comparative example may generate the segmentation loss 570 based on the segmentation image GT and the segmentation image 550. Furthermore, the multi-task learning method according to a comparative example may perform learning on the multi-task encoder 510 and the segmentation decoder 530 based on the segmentation loss 570. In other words, unlike the multi-task learning method according to an embodiment of the present disclosure, the multi-task learning method according to a comparative example may perform multi-task learning based on only the segmentation loss 570 without a consistency loss.

The segmentation image 620 and the depth image 640 may be created by entering the new input image 610 into a model from performing multi-task learning based on the segmentation loss 570 without a consistency loss. Referring to the image 630 obtained by projecting the segmentation image 620 onto the input image 610, it may be seen that the segmentation image 620 matches the input image 610 because learning was performed based on GT for the segmentation image.

However, a lower portion 641 corresponding to the ground of the depth image 640 is perceived as being located far away even though the lower portion 641 is a close to a sensor. Accordingly, it may be seen that the depth image 640 and the input image 610 do not match each other well in a lower portion 651 of the image 650 obtained by projecting the depth image 640 onto the input image 610.

In other words, if a multi-task model is learned by calculating a loss only for a task with GT, an encoder (a multi-task encoder) shared by two tasks is learned to increase only the performance of the task with GT, and thus the learning of the other task may become unstable. For example, as the multi-task model does not include GT data, the task without a loss may be perceived as including a loss of 0, and thus there is no need for further learning. As a result, learning for the task without GT may become unstable.

On the other hand, the multi-task learning method according to an embodiment of the present disclosure may generate a consistency loss by using a pretrained encoder for the task without GT and may perform multi-task learning in consideration of both the loss and the consistency loss for the task with GT. Accordingly, the multi-task encoder may improve the performance of both tasks equally.

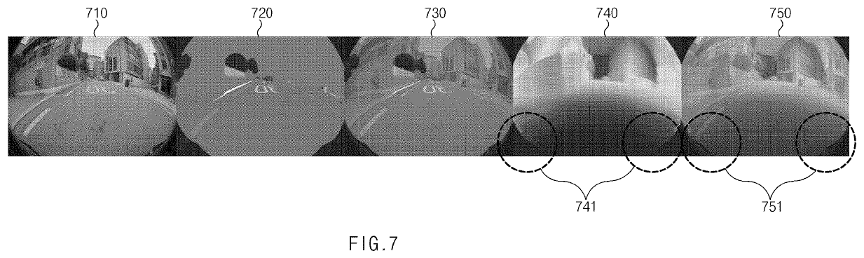

FIG. 7 is a diagram for describing a multi-task learning method, according to an embodiment of the present disclosure.

The drawings shown in FIG. 7 are an input image 710, a segmentation image 720 generated based on the input image 710 through a model learned in a multi-task learning method according to an embodiment of the present disclosure, an image 730 obtained by projecting the segmentation image 720 onto the input image 710, a depth image 740 created based on the input image 710, and an image 750 obtained by projecting the depth image 740 onto the input image 710.

The multi-task learning method according to an embodiment of the present disclosure may generate a consistency loss by using a pretrained encoder for the task without GT and may perform multi-task learning in consideration of both the loss and the consistency loss for the task with GT. Accordingly, the multi-task encoder may improve the performance of both tasks equally. In detail, the multi-task learning method may generate features by using a pretrained encoder in relation to depth estimation if there is segmentation GT, may generate a consistency loss based on an output feature of the multi-task encoder and an output feature of the pretrained encoder, and may learn a multi-task model based on a loss and a consistency loss generated based on a segmentation decoder.

Referring to the image 730, because multi-task learning is performed in a situation where there is segmentation GT, it may be seen that the input image 710 matches the segmentation image 720.

Moreover, even though the multi-task learning is performed in a situation where there is no depth GT, the multi-task learning method according to an embodiment of the present disclosure performs learning by generating a consistency loss by using a pretrained encoder in relation to depth estimation, thereby achieving stable learning on a depth estimation task. Accordingly, unlike in an embodiment of FIG. 6, stable results are obtained without a portion recognized as being far from a lower portion 741 corresponding to the ground surface of the depth image 740. Referring to the image 750 and the lower portion 751 of the image 750, it may be seen that the input image 710 matches the depth image 740 well.

That is, according to the multi-task learning method according to an embodiment of the present disclosure, even though the multi-task model is learned by using partially annotated data, learning may be prevented from being biased toward the task with GT.

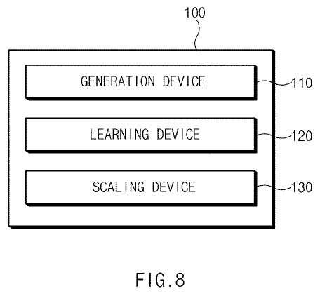

FIG. 8 is a block diagram of a multi-task learning apparatus, according to an embodiment of the present disclosure.

Referring to FIG. 8, a multi-task learning apparatus 100 according to an embodiment of the present disclosure may include a generation device 110, a learning device 120, and a scaling device 130. Each of the generation device 110, the learning device 120, and the scaling device 130 may correspond to a processor. Also, although not shown in FIG. 8, the multi-task learning apparatus may include a memory configured to store computable-executable instructions, and the processor may be configured to access memory and to execute the instructions.

The generation device 110 may generate a first feature based on a first input image by using a multi-task encoder. Moreover, the generation device 110 may generate a first output image based on the first feature by using a first decoder for a first task. Furthermore, the generation device 110 may generate a first loss based on the first output image and the first GT for the first task. Also, the generation device 110 may generate a second feature based on the first input image by using a first encoder pretrained for a second task. In addition, the generation device 110 may generate a second loss based on the first feature and the second feature.

Besides, the generation device 110 may generate a third feature based on a second input image by using the multi-task encoder. Moreover, the generation device 110 may generate a second output image based on the third feature by using a second decoder for the second task. Furthermore, the generation device 110 may generate a third loss based on the second output image and the second GT for the second task. Also, the generation device 110 may generate a fourth feature based on the second input image by using a second encoder pretrained for the first task. In addition, the generation device 110 may generate a fourth loss based on the third feature and the fourth feature.

The learning device 120 may learn the multi-task encoder and the first decoder based on the first loss and the second loss. Moreover, the learning device 120 may learn the multi-task encoder and the second decoder based on the third loss and the fourth loss.

The scaling device 130 may scale the first feature to correspond to the second feature. For example, the scaling device 130 may scale the first feature by inputting the first feature into a convolution layer.

In addition, the generation device 110 may generate the second loss based on the scaled first feature and the second feature. Also, the generation device 110 may generate the second loss by calculating a distance between the scaled first feature and the second feature.

Moreover, the first encoder pretrained for the second task may be an encoder with a structure the same as the multi-task encoder. Furthermore, the second encoder pretrained for the first task may be an encoder with a structure the same as the multi-task encoder.

The first task may be image segmentation, and the second task may be depth estimation. On the other hand, the first task may be depth estimation, and the second task may be image segmentation.

Assuming that the first task is depth estimation, the generation device 110 may generate the first output image based on the first feature and camera calibration information.

The learning device 120 may learn the multi-task encoder and the first decoder after freezing the pretrained first encoder. Moreover, the learning device 120 may learn the multi-task encoder and the second decoder after freezing the pretrained second encoder.

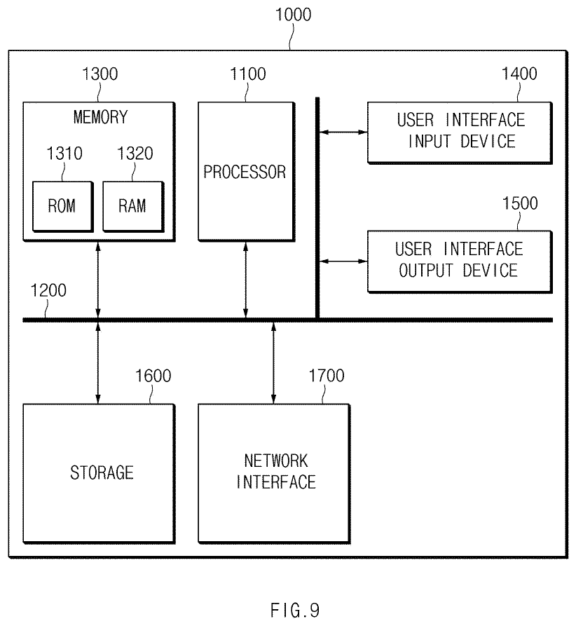

FIG. 9 is a block diagram of a computing system for executing a multi-task learning method, according to an embodiment of the present disclosure.

Referring to FIG. 9, a method of determining fail-safe of camera image recognition according to an embodiment of the present disclosure described above may be implemented through a computing system 1000. The computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600.

The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component. The above description is merely an example of the technical idea of the present disclosure, and various modifications and modifications may be made by one skilled in the art without departing from the essential characteristic of the present disclosure. Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

According to an embodiment of the present disclosure, semi-supervised learning may be performed on a multi-task model.

According to an embodiment of the present disclosure, multi-task learning may be performed on a depth image by using camera calibration information.

According to an embodiment of the present disclosure, semi-supervised learning may be performed on a multi-task model without an additional module.

According to an embodiment of the present disclosure, learning may be performed such that a cosine distance between an output feature of a single model encoder of a task without GT and an output feature of a multi-task encoder is closer.

According to an embodiment of the present disclosure, learning may be prevented from being biased towards a task with GT even though a multi-task learning model is learned based on partially annotated data.

According to an embodiment of the present disclosure, because back propagation does not occur in a depth decoder if learning is performed based on segmentation labeled data, multi-task learning may be performed without camera calibration information.

According to an embodiment of the present disclosure, multi-task learning may be performed even though the types of inputs are different from each other.

Effects obtained in the present disclosure are not limited to the above-mentioned effects, and other effects that are not mentioned will be clearly understood by those skilled in the art, to which the present disclosure belongs, from the following description.

Hereinabove, although the present disclosure was described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A multi-task learning method, the method comprising:
generating, by a generation device, a first feature based on a first input image through a multi-task encoder;
generating, by the generation device, a first output image based on the first feature through a first decoder for a first task;
generating, by the generation device, a first loss based on the first output image and a first ground truth (GT) for the first task;
generating, by the generation device, a second feature based on the first input image through a pretrained first encoder for a second task;
generating, by the generation device, a second loss based on the first feature and the second feature; and
learning, by a learning device, the multi-task encoder and the first decoder based on the first loss and the second loss.

2. The method of claim 1, further comprising:
generating, by the generation device, a third feature based on a second input image through the multi-task encoder;
generating, by the generation device, a second output image based on the third feature through a second decoder for the second task;
generating, by the generation device, a third loss based on the second output image and a second GT for the second task;
generating, by the generation device, a fourth feature based on the second input image through a pretrained second encoder for the first task;
generating, by the generation device, a fourth loss based on the third feature and the fourth feature; and
learning, by the learning device, the multi-task encoder and the second decoder based on the third loss and the fourth loss.

3. The method of claim 1, wherein the generating of the second loss includes:
scaling, by a scaling device, the first feature to correspond to the second feature; and
generating, by the generation device, the second loss based on the scaled first feature and the second feature.

4. The method of claim 3, wherein the scaling of the first feature includes:
scaling, by the scaling device, the first feature by inputting the first feature into a convolution layer.

5. The method of claim 3, wherein the generating of the second loss includes:
generating, by the generation device, the second loss by calculating a distance between the scaled first feature and the second feature.

6. The method of claim 1, wherein the pretrained first encoder for the second task is an encoder with a structure that is the same as a structure of the multi-task encoder.

7. The method of claim 1, wherein the first task is an image segmentation task, and
wherein the second task is a depth estimation task.

8. The method of claim 1, wherein the generating of the first output image includes:
generating, by the generation device, the first output image based on the first feature and camera calibration information.

9. The method of claim 1, wherein the learning of the multi-task encoder and the first decoder includes:
learning, by the learning device, the multi-task encoder and the first decoder while fixing a parameter of the pretrained first encoder.

10. A multi-task learning apparatus comprising:
a memory configured to store computer-executable instructions;
a generation device including a first processor configured to access the memory and to execute the computer-executable instructions, wherein the generation device is configured to generate a first feature based on a first input image by using a multi-task encoder, generate a first output image based on the first feature by using a first decoder for a first task, generate a first loss based on the first output image and a GT for the first task, generate a second feature based on the first input image by using a pretrained first encoder for a second task, and generate a second loss based on the first feature and the second feature; and
a learning device including a second processor configured to access the memory and to execute the computer-executable instructions, wherein the learning device is configured to learn the multi-task encoder and the first decoder based on the first loss and the second loss.

11. The multi-task learning apparatus of claim 10, wherein the generation device is configured to generate a third feature based on a second input image by using the multi-task encoder, generate a second output image based on the third feature by using a second decoder for the second task, generate a third loss based on the second output image and a second GT for the second task, generate a fourth feature based on the second input image by using a pretrained second encoder for the first task, and generate a fourth loss based on the third feature and the fourth feature; and
the learning device is configured to learn the multi-task encoder and the second decoder based on the third loss and the fourth loss.

12. The multi-task learning apparatus of claim 10, further comprising a scaling device including a third processor configured to access the memory and to execute the computer-executable instructions, wherein the scaling device is configured to
scale the first feature to correspond to the second feature; and
wherein the generation device is configured to generate the second loss based on the scaled first feature and the second feature.

13. The multi-task learning apparatus of claim 12, wherein the scaling device is configured to scale the first feature by inputting the first feature into a convolution layer.

14. The multi-task learning apparatus of claim 12, wherein the generation device is configured to generate the second loss by calculating a distance between the scaled first feature and the second feature.

15. The multi-task learning apparatus of claim 10, wherein the first encoder pretrained for the second task is an encoder with a structure that is the same as a structure of the multi-task encoder.

16. The multi-task learning apparatus of claim 10, wherein the first task is an image segmentation task, and wherein the second task is a depth estimation task.

17. The multi-task learning apparatus of claim 10, wherein the generation device is configured to generate the first output image based on the first feature and camera calibration information.

18. The multi-task learning apparatus of claim 10, wherein the learning device is configured to learn the multi-task encoder and the first decoder while fixing a parameter of the pretrained first encoder.
